(19) United States
(12) Patent Application Publication
(10) Pub. No.: US 2007/0075065 A1
(43) Pub. Date: Apr. 5, 2007

(54) Fixing device and image forming apparatus

(75) Inventor: Noriyuki Miyoshi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/342,643

(22) Filed: Jan. 31, 2006

(30) Foreign Application Priority Data
Sep. 21, 2005 (JP) P2005-274516

(51) Int. Cl. H05B 3/00; H05B 1/00; H05B 11/00

(52) U.S. Cl. 219/216

(57) ABSTRACT

A fixing device fixes a toner image on a recording material. The fixing device has a fixing member having a heat source, a sensor which senses a surface temperature of the fixing member, a measuring section which obtains temperature-rising time information of the fixing member based on information from the sensor, an abnormality determining section which compares the temperature-rising time information obtained by the measuring section with reference value information to determine whether or not an abnormality exists, and an adjusting section which adjusts the reference value information of the abnormality determining section.

### CROSS-REFERENCE TO RELATED APPLICATIONS

This application is based upon and claims the benefit of priority from the prior Japanese Patent Applications No. 2005-274516, filed on Sep. 21, 2005, the entire contents of which are incorporated herein by reference.

### BACKGROUND OF THE INVENTION

1. Field of the Invention

The present invention relates to an image forming apparatus such as a copy machine or a printer. More specifically, the present invention relates to improvement of a fixing device with high safety against troubles caused by jamming of recording materials and an image forming apparatus using the fixing device.

2. Description of the Related Art

As a fixing device for fixing toner of a recording material in an image forming apparatus employing an electrophotography method, for example, there has been conventionally known a device using a heating roll with simple conditions on heat and pressure in a fixing process. In this device, the heating roll is disposed on at least a toner image side on the recording material, and the toner is fixed when the recording material is nipped and conveyed between the heating roll and a pressure roll.

However, in such a fixing device, if a pressure applied to the recording material against the heating roll is increased due to any causes when the recording material is discharged from the fixing device, the recording material is wound around the heating roll. Typically, since such winding of the recording material is eliminated when a jam cleared, it causes little trouble.

However, in a recent high speed image forming apparatus, for example when a jam occurs as the recording material is wound around the heating roll in the fixing process, even though the jam is cleared, not all the recording materials to be removed may be removed since a user can not find subsequent recording materials remaining in the apparatus. In this case, the apparatus may be started though the subsequent recording materials are remaining without being removed, and the recording materials are newly wound around the heating roll after the clearance of jam. In addition, in the case of winding jam, since it is difficult to find the wound recording material, the apparatus may often be restarted without removing the wound recording material.

In the mean time, at a surface side of the heating roll of the fixing device is typically provided a temperature sensor for controlling heating of the heating roll, and the supply of power to the heating roll is controlled by the temperature sensor.

In this case, when the heating roll begins to heat by warming up after occurrence of the jam, the power continues to be supplied to the heating roll and the temperature of the heating roll continues to increase until the temperature of the heating roll reaches a reference value set by the temperature sensor under control by the temperature sensor.

At this time, if the recording material is wound around the heating roll, temperature sensed by the temperature sensor is lower than an actual temperature due to the wound recording material. Accordingly, since a correct heating control of the heating roll is not achieved, smoke may be emitted due to abnormal increase of the temperature of the heating roll, which may result in outbreak of a fire.

### SUMMARY OF THE INVENTION

The present invention provides a fixing device with high safety against troubles caused by jamming of recording materials and an image forming apparatus using the fixing device.

According to an aspect of the present invention, a fixing device for fixing a toner image on a recording material includes a fixing member having a heat source, a sensor which senses a surface temperature of the fixing member, a measuring section which obtains temperature-rising time information of the fixing member based on information from the sensor, an abnormality determining section which compares the temperature-rising time information obtained by the measuring section with reference value information to determine whether or not an abnormality exists, and an adjusting section which adjusts the reference value information of the abnormality determining section. Various errors such as abnormality of winding of recording materials around the fixing member can be detected under a state adapted to installation environment conditions of the fixing device.

In addition, by using the fixing device, it is possible to provide an image forming apparatus adapted to installation environments and having high safety.

### BRIEF DESCRIPTION OF THE DRAWINGS

FIG. 1 is an explanatory view showing an outline of a fixing device according to the present invention;

FIG. 2 is an explanatory view showing an embodiment of an image forming apparatus according to the present invention;

FIG. 3 is an explanatory view showing a fixing device according to the embodiment of the present invention;

FIG. 4 is a block diagram showing a controller according to the embodiment of the present invention;

FIG. 5 is a flow chart illustrating an adjusting method according to the embodiment of the present invention;

FIG. 6 is an explanatory view showing an example of a temperature profile according to the embodiment of the present invention; and

FIG. 7 is an explanatory view showing a result of an experiment of the present invention.

### DETAILED DESCRIPTION OF THE INVENTION

An outline and embodiment of the present invention will be described in detail with reference to the accompanying drawings.

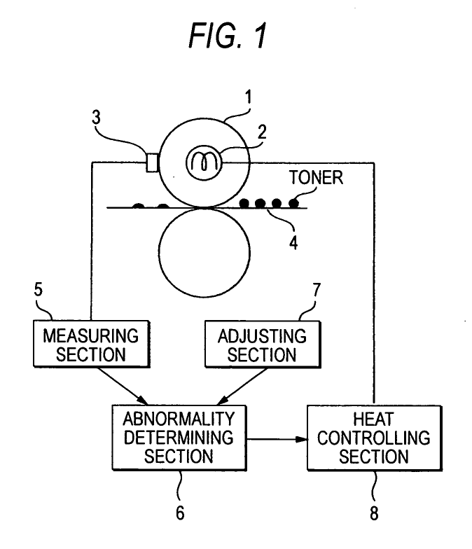

As shown in FIG. 1, a fixing device for fixing a toner image on a recording material 4 includes a fixing member 1 having a heat source 2, a temperature sensor 3 for sensing a surface temperature of the fixing member 1, a measuring section 5 for obtaining temperature-rising time information based on information from the temperature sensor 3 under a condition of operating the fixing member 1 in a heating mode, an abnormality determining section 6 for comparing the temperature-rising time information obtained by the measuring section 5 with reference value information to determine the presence of abnormality, and an adjusting section 7 for adjusting the reference value information of the abnormality determining section.

The fixing member 1 has no particular limitation in the number of the heat source 2 and either of a roll-type or a belt-type fixing member may be used. In addition, the heat source 2 may be included either inside or outside the fixing member 1. In addition, the fixing member 1 typically includes a heating roll containing the heat source 2 and a pressure roll disposed opposite to the heating roll.

The temperature sensor 3 has no particular limitation in its number if only it can detect the surface temperature of the fixing member 1. For example, the temperature sensor 3 may include thermosensitive elements such as thermistors or optical elements for detecting infrared ray, which contact with or are isolated from the fixing member 1.

The measuring section 5 may obtain the temperature-rising time information based on information from the temperature sensor 3 under a condition of operating the fixing member 1 in a heating mode. Here, “the temperature-rising mode” means heating to raise a temperature in the warming-up time, including equilibrium state. In addition, “the temperature-rising time information” includes time itself and information related to the time indirectly.

The fixing device further includes a heat controlling section 8 for supplying power to the heat source 2 and lowering the supply of the power if the abnormality determining section 6 determines that there exists abnormality. Even when the recording material 4 is wound around the fixing member 1, the temperature of the heat source 2 may be effectively lowered, thus improving safety. In addition, the heat controlling section 8 may lower the supply of power to the heat source 2, or, preferably, stop the supply of power in order to further improve the safety.

The abnormality determining section 6 compares the temperature-rising time information with the reference value information to determine the abnormality. For example, the abnormality determining section 6 may determine the abnormality based on the fact that the temperature-rising time becomes longer when the recording material 4 is wound around the fixing member 1.

The adjusting section 7 adjusts the reference value information of the abnormality determining section 6 based on installation environment conditions, for example. In this case, the installation environment conditions may include temperature, humidity, power voltage, deviations of parts, etc. In addition, by performing such an adjustment, it is possible to prevent malfunction in the error detection in the installation environments.

The adjusting section 7 may not operate under a condition where the temperature of the fixing member 1 before the fixing device begins to be heated is equal to or higher than a predetermined temperature. For example, if the adjusting section 7 sets the reference value above the predetermined temperature, it is difficult to obtain an effective reference value. Temperature decided in advance is used as the predetermined temperature. In addition, preferably, the adjusting section 7 operates at an initial starting of the fixing device after installation of the fixing device or exchange of the fixing device member 1. With this configuration, the reference value can be set according to the installation environments in which the fixing device is installed. Accordingly, various errors related to the fixing device, such as abnormality of winding of recording materials, can be effectively detected. In addition, preferably, the adjusting section operates after a password is input. With this configuration, for example, since only a specified person such as a service person is authorized to set the reference value, there is no careless change of the reference value, thus allowing more accurate error detection and hence higher safety.

The adjusting section 7 may repeatedly operate to set the reference value repeatedly until the abnormality determining section determines that errors such as abnormality of winding of recording materials first occurs in the fixing device. With this configuration, the reference value adapted to the installation environments can be set. In addition, the adjusting section 7 may set a new reference value, with an adjustment value thereof being gradually small, based on the obtained temperature-rising time information, every time the reference value is repeatedly set. In this manner, by making the adjustment small gradually, the reference value having high precision can be set. Accordingly, detection performance for various errors related to the fixing device, such as abnormality of winding of recording materials, can be improved, thus allowing higher safety of the fixing device. In addition, preferably, the adjusting section 7 sets the reference value based on the temperature-rising time information between at least two different temperatures before the surface temperature of the fixing member 1 reaches a fusible temperature. This is preferable since the temperature before the fixing device member 1 is rotated can be stably measured by the temperature sensor 3.

The fixing member 1 may have identification information different from information of other fixing members and the adjusting section 7 operates when new identification information is recognized. With this configuration, the adjusting section 7 can easily recognize the exchange of the fixing member 1. Accordingly, the reference value adapted to the fixing member 1 can be set and deviations of parts can be absorbed even when the fixing member 1 is exchanged. In this case, the identification information can be easily implemented by a memory element such as a label on which identification information is recorded.

The fixing member 1 may include an irreversible reaction member for generating a state change by an irreversible reaction when the surface temperature of the fixing member 1 reaches a predetermined temperature before the surface temperature reaches a fusible temperature, and the adjusting section 7 sets the reference value when the irreversible reaction member does not show the irreversible reaction. With this configuration, it is possible to set the reference value under a condition where the fixing device does not reach a predetermined temperature, thus allowing the reference value to be set in compliance with only the installation environments. In this case, as examples of the irreversible reaction member and the irreversible reaction, there may be a temperature fuse and a cutting state thereof, paramagnetism using Curie temperature of magnetic material, color change using thermo-paint, etc, but, preferably the temperature fuse from a point of view of low costs. A single-operation bimetal thermostat may also be used.

The abnormality determining section 6 may compare the temperature-rising time information between the at least two different temperatures during warming up and time information on consecutive application of current to the heat source 2 under a standby state and determines that there occurs abnormality when it is determined that at least one of the temperature-rising time information and the time information on consecutive application of current to the heat source is abnormal. With this configuration, it is possible to perform error detection by plural check items based on the reference value information.

The fixing device may include plural temperature sensors 3, the adjusting section 7 sets the reference value for each of the plural temperature sensors, and the abnormality determining section 6 compares plural temperature-rising time information items obtained based on information from respective temperature sensors 3 with respective reference information items and determines that there occurs abnormality when it is determined that there exists abnormality in at least one or plural temperature-rising time information items. With this configuration, when various errors such as abnormality of winding of recording materials around the fixing member 1 are detected, there is an effect of high safety and reliability.

An image forming apparatus includes an image forming section for forming a toner image on a recording material 4 and the above fixing device.

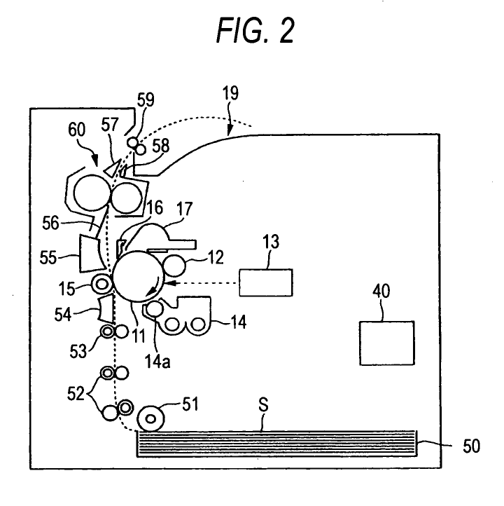

FIG. 2 is an explanatory view showing an embodiment of the image forming apparatus according to the present invention. As shown in FIG. 2, in an image forming apparatus according to this embodiment, a photoconductor drum 11 as an image carrier is disposed at an approximate central portion of the apparatus, a paper feeding cassette 50 for accommodating papers S as recording materials is disposed at a lower portion of the apparatus, and a fixing device 60 for fixing a toner image formed on the papers S by the photoconductor drum 11 is disposed at an upper portion of the apparatus.

In the image forming apparatus as configured above, a conveying path along which the papers S are conveyed can be made very short, and most of the conveying path of the papers S can be easily exposed only by opening one side cover of the image forming apparatus. Accordingly, time taken from feeding to discharging of the papers S can be shortened, while conveyability of the paper S is improved and removability of the papers S at the time of jamming is excellent.

In addition, around the photoconductor drum 11 are arranged electrophotographic devices such as a charging section 12 such as a charging roll for charging the photoconductor drum 11, an exposure section 13 such as a laser exposure device for recording an electrostatic latent image on the charged photoconductor drum 11, a developing section 14 for visualizing the electrostatic latent image recorded on the photoconductor drum 11 by toner, a transfer section 15 such as a transfer roll for transferring a visualized toner image formed on the photoconductor drum 11 onto the papers S, and a drum cleaner 17 for removing residual toner on the photoconductor drum 11.

In addition, a paper conveyance system in the image forming apparatus according to this embodiment includes the paper feeding cassette 50 for accommodating the papers S, a pickup roll 51 for feeding the papers S accommodated in the paper feeding cassette 50 at a predetermined timing, a conveying roll 52 for conveying the papers S fed by the pickup roll 51, a registration roll 53 for regulating positioning of the papers S conveyed by the conveying roll 52 and feeding the papers S to the transfer section 15 at a predetermined timing, an inlet chute 54 for guiding the papers S fed from the registration roll 53 to a nip portion (a portion between the photoconductor drum 11 and the transfer section 15), a conveying guide 55 for conveying the papers S, which are conveyed after the toner image is transferred onto the papers S by the transfer section 15, to the fixing device 60, a fixing inlet guide 56 disposed upstream of the fixing device 60 for guiding the papers S, with the toner image transferred thereon, to the fixing device 60, and paper discharging guides 57 and 58 for guiding the papers S to a discharging roll 59 for discharging the papers S, which are discharged from the fixing device 60, to an accommodating tray 19 provided on a casing surface of the image forming apparatus. In addition, in the figure, reference numeral “16” denotes a peeling claw for preventing the transferred papers S from being wound around the photoconductor drum 11. In addition, inside the image forming apparatus is provided a controller 40 for controlling various parts of the apparatus.

Next, the fixing device 60 according to this embodiment will be described.

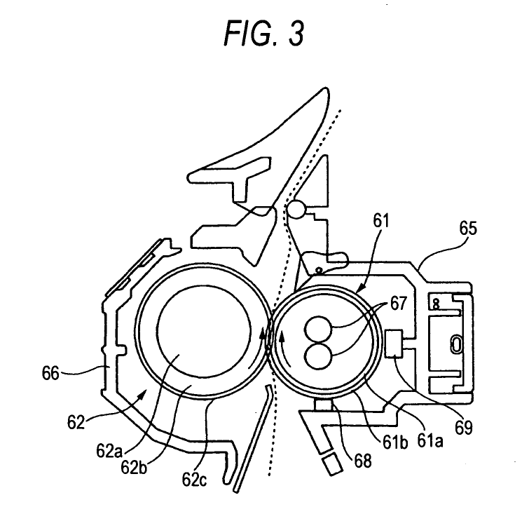

As shown in FIG. 3, the fixing device 60 according to this embodiment includes a heating-side case 65 for rotatably supporting a heating roll 61 and a pressurizing-side case 66 for rotatably supporting a pressure roll 62, which are interconnected at a region (not shown), thereby forming one unit. In addition, the fixing device 60 is mounted in the image forming apparatus such that a straight line connecting a center of the heating roll 61 and a center of the pressure roll 62 lies in a substantially horizontal direction. At this time, the pressure roll 62 is pressed against the heating roll 61 by an elastic member such as a spring (not shown), such that a fixed nip is formed therebetween.

In the heating roll 61, a surface of a rigid cylindrical core 61a made of metal having good thermal conductivity, such as aluminum, is coated with a release layer 61b having good release characteristics with the toner containing silicon resin, fluorine resin or the like, and heat-resistance. From a point of view of the release characteristics with the toner and abrasion-resistance, the release layer 61b may be made of the fluorine resin, particularly, a co-polymer of tetrafluoroethylene and perfluoroalkylvinylether (PFA), polytetrafluoroethylene (PTFE), a co-polymer of tetrafluoroethylene and hexafluoropropylene (FEP), etc.

In addition, for example, inside the heating roll 61 is disposed a halogen heater 67 to heat the heating roll 61 internally. In addition, a temperature sensor 68 in addition to a paper conveyance region is disposed in contact with a surface of the heating roll 61. In addition, a thermostat 69 for controlling a reaching temperature of the heating roll 61 is disposed, with a gap between the thermostat 69 and the heating roll 61, upstream of a rotation direction of the heating roll 61 from the temperature sensor 68.

In the mean time, the pressure roll 62 includes, for example, a cylindrical metal shaft 62a, a heat-resistant elastic layer 62b provided around the metal shaft 62a, and a release layer 62c covering a surface of the heat-resistant elastic layer 62b. The metal shaft 62a is made of, for example, steel or aluminum and may have a hollow shape. In addition, the heat-resistant elastic layer 62b is made of, for example, silicon sponge rubber or silicon rubber having good heat-resistance and mechanical strength. In addition, the release layer 62c is similar to the release layer 61b of the heating roll 61.

In this embodiment, the heating roll 61 and the pressure roll 62 are configured as described above, and, when the pressure roll 62 pressurizes the heating roll 61, a fixed nip region is regularly formed.

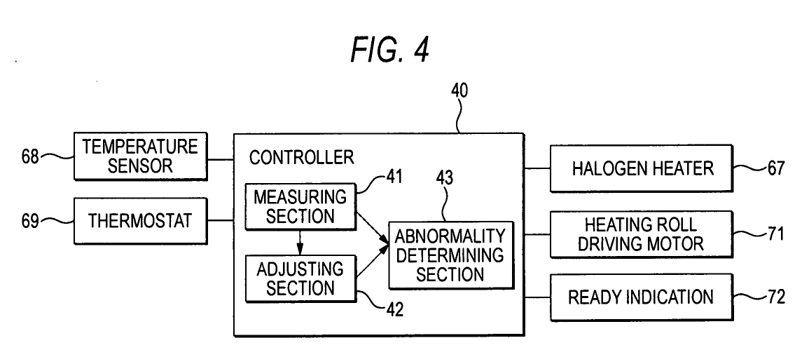

In this embodiment, the heat control of the fixing device 60 is performed by the controller 40, as shown in FIG. 4. Input information for the controller 40 includes temperature information from the temperature sensor 68, ON/OFF information from the thermostat 69 (for example, the thermostat 69 is turned OFF when temperature of the heating roll 61 exceeds a preset temperature), etc. Based on a result of process by the controller 40, an ON/OFF operation of the halogen heater 67 of the heating roll 61 is controlled, an ON/OFF operation of a heating roll driving motor 71 (not shown in FIGS. 2 and 3) is controlled, and a READY indication is displayed on a UI (User Interface) screen). In addition, the controller 40 includes a measuring section 41 for obtaining temperature-rising time taken for temperature-rising of the heating roll 61 based on temperature data from the temperature sensor 68, an adjusting section 42 for adjusting the temperature-rising time obtained by the measuring section 41 based on install environments and setting new reference time, and an abnormality determining section 43 for comparing the temperature-rising time obtained by the measuring section 41 with the set reference time and determining the presence of errors such as abnormality of winding of papers around the heating roll 61.

Next, a basic image forming process of the image forming apparatus according to this embodiment will be described.

As shown in FIG. 2, the exposure section 13 controlled by an image processing apparatus (not shown) forms an electrostatic latent image on the photoconductor drum 11 charged by the charging section 12. The electrostatic latent image on the photoconductor drum 11 is visualized as a toner image by a developing roll 14a of the developing section 14.

In the mean time, the papers S fed from the paper feeding cassette 50 by the pickup roll 51 are led to the registration roll 53 via the conveying roll 52, position of the papers S is regulated by the registration roll 53, and then, the regulated papers S reach the transfer section 15 via the inlet chute 54.

In the transfer section 15, the toner image on the photoconductor drum 11 is transferred on the conveyed papers S, and the paper S on which the toner image is transferred reach the fixing device 60 via the conveying guide 55 and the fixing inlet guide 56. The papers S with the toner image fixed by the fixing device 60 are discharged into the accommodating tray 19 via the paper discharging guides 57 and 58 and the discharging roll 59.

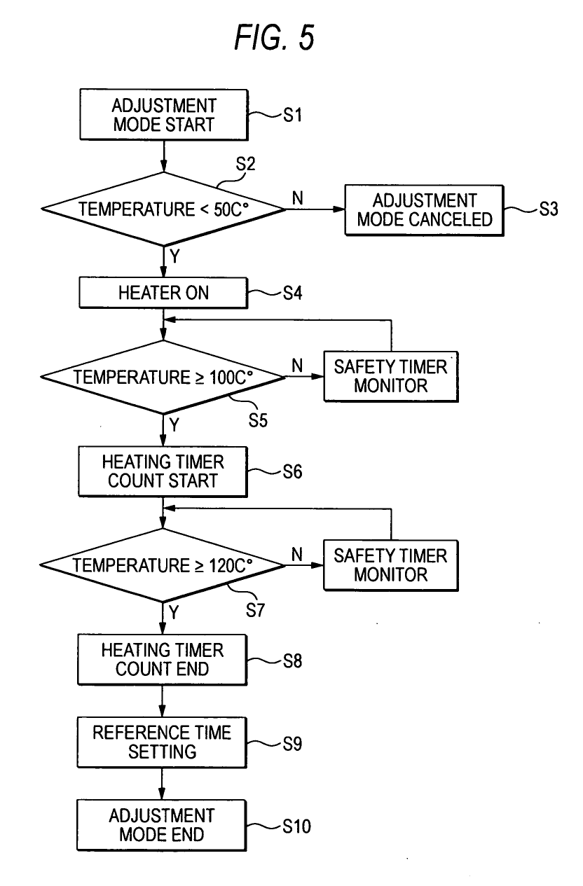

Now, in the above image forming process, a method of setting the reference time in the controller 40 according to this embodiment will be described with reference to a flow chart of an adjustment mode of FIG. 5.

In this embodiment, an adjustment mode is performed when an image forming apparatus is newly installed. The adjustment mode is started when a power source of the image forming apparatus (M/C power source) is turned ON, for example, and it is determined whether or not a surface temperature of the heating roll 61 sensed by the temperature sensor 68 is less than 50° C. If the surface temperature is equal to or higher than 50° C., it is determined that the adjustment mode is not properly performed, and accordingly, the adjustment mode is canceled and the M/C power source is turned OFF, for example (Steps S1 to S3).

On the other hand, if the surface temperature of the heating roll 61 is less than 50° C., current begins to flow into the halogen heater 67, and abnormality in a tendency of temperature rising is monitored using a safety timer until the surface temperature of the heating roll 61 sensed by the temperature sensor 68 reaches 100° C. (Steps S4 and S5). Here, the safety timer is used not to check errors such as abnormality of winding of papers around the heating roll 61, but to monitor the temperature-rising time, which may be defined by time taken for the surface temperature of the heating roll 61 to rise to 50 to 100° C. by normal heating plus a marginal rate, for monitor of possible defects of the halogen heater 67. In addition, in this embodiment, when the temperature-rising time exceeds time set by the safety timer, the M/C power source is turned OFF, for example.

Next, if the temperature of the heating roll 61 reaches 100° C., a temperature-rising timer provided in the controller 40 starts to count, and, if the temperature of the heating roll 61 reaches 120° C., the temperature-rising timer ends to count (Steps S6 to S8). Then, a count value of the temperature-rising timer is adjusted to set new reference time and then end the adjustment mode (Steps S9 and S10). In addition, the safety timer in Step S7 operates in a manner similar to the above-mentioned safety timer.

The above-described adjustment performed based on the count value of the temperature-rising timer has no particular limitation if the adjustment is performed to have more than the count value. However, if the count value is excessively large, there is a possibility of no detection of errors such as abnormality of winding of papers. On the other hand, if the count value is excessively small, there is a possibility of malfunction of the apparatus. Accordingly, an adjustment value is typically set within 1 to 1.5 times of the count value of the temperature-rising timer. Details of the adjustment value will be described in a later embodiment.

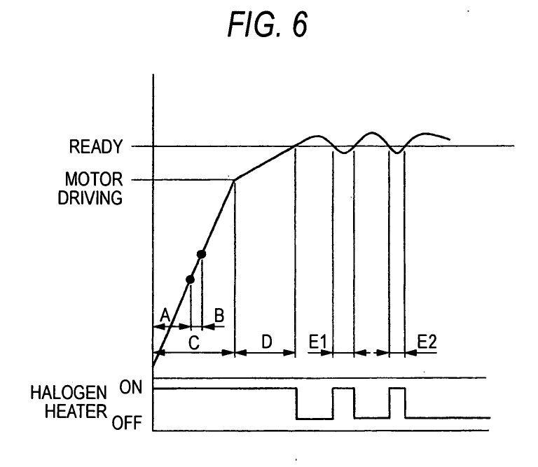

In this embodiment, in addition to the adjustment at the time of setting the reference time by the above-mentioned temperature-rising timer, various error detection is performed, contents of which will be described using a temperature profile shown in FIG. 6.

FIG. 6 shows a temperature profile (measured by the temperature sensor 68) of the heating roll 61 at the time of warming up, where a vertical axis represents temperature and a horizontal axis represents time. When the halogen heater 67 is turned ON, the temperature of the heating roll 61 begins to rise substantially linearly. When the heating roll 61 reaches a particular temperature, the heating roll driving motor 71 is turned ON to start rotation of the heating roll 61. When the heating roll 61 begins to rotate, with a speed of temperature rising lowered slightly, the heating roll 61 reaches a fixable temperature and the halogen heater 67 is turned OFF to enter a standby state (corresponding to Ready in the figure). Thereafter, the emission of heat from the heating roll 61 and the turning on of the halogen heater 67 are repeated to maintain the standby state.

In this temperature profile, in this embodiment, to avoid various abnormalities of the fixing devices 60, it is determined whether or not there exist abnormalities in the fixing device 60 by providing timers corresponding to A to E2 regions in the figure and comparing temperature-rising time in each region sensed by the temperature sensor 68 with respective reference time. That is, temperature-rising time from 50° C. to a temperature-rising measurement starting point (100° C.) is measured in the A region using an A timer, temperature-rising time from 100° C. to 120° C. is measured in the B region using a B timer, temperature-rising time from 50° C. to a temperature at which the heating roll driving motor 71 begins to be driven is measured in the C region using a C timer, and temperature-rising time from the temperature at which the heating roll driving motor 71 begins to be driven to a temperature at which the fixing device 60 reaches Ready is measured in the D region using a D timer. In addition, lighting time of the halogen heater 67 in the standby state (lighting time after the fixing device 60 reaches Ready at the time of warming up) is measured in the E1 and E2 regions using respective E1 and E2 timers.

In this embodiment, an adjustment shown in FIG. 5 is first performed in the B region in order to set adjusted reference time. Then, based on the adjusted reference time, reference values in other regions (corresponding to respective reference time in respective regions) are determined. In addition, assuming winding of papers around the heating roll 61, the temperature-rising time by the halogen heater 67 becomes further long, as compared to a state of no winding of papers. Accordingly, the reference time in the respective regions may be adjusted by being multiplied with predetermined magnification for the respective regions based on the reference time set in the B region. Such an adjustment allows detection of various errors including the abnormality of the winding of papers, such as lowering of commercial power, abnormality of the temperature sensor 68 (separation of the sensor from the heating roll 61 or defects of the sensor), defects of the halogen heater 67, etc. In addition, in order to set the reference values (reference time in this embodiment) in other regions based on the reference time in the B region, it goes without saying that the adjustment is achieved based on a verification result by an image forming apparatus of the same type. In addition, it makes no difference to set the reference time in the respective regions based on the temperature-rising time measured in the respective regions.

As described above, in this embodiment, since the reference time in each temperature region is set as an adjusted value after the image forming apparatus is installed, the reference time can be set in compliance with conditions of installation environments and the detection of various errors such as the abnormality of winding of papers can be effectively performed, which may result in prevention of wrong detection. In addition, variations in manufacture of fixing devices can be absorbed. In addition, even when a user is compelled to use the image forming apparatus outside a range of operation guarantee depending on installation environments, the abnormality can be detected without any malfunction. In addition, in this case, it goes without saying that images themselves can be formed or adjusted with good quality.

In addition, by repeating such an adjustment and decreasing an adjustment width every time the adjustment is performed, the detection of abnormalities (errors) can be even more precisely achieved and the malfunction of the apparatus can be further reduced. In addition, if only a specified person such as a service person is authorized to perform such an adjustment using password or the like, it is possible to perform the image formation and the abnormality detection at once.

In addition, when parts such as the fixing device and the heating roll are exchanged, the abnormality detection can continue to be performed by performing an adjustment after the exchange of parts.

Although the temperature sensor 68 is used alone in this embodiment, plural temperature sensors 68 may be used. In this case, the above-described adjustment is performed for each of temperature sensors 68, and, if it is determined that there occurs abnormality in even one temperature sensor 68, the supply of power to the halogen heater 67 is interrupted, which may result in higher safety. In the mean time, if it is determined that there occurs abnormality in the plural temperature sensors 68, the supply of power to the halogen heater 67 is interrupted, which may result in abnormality detection with little malfunction.

Although the image forming apparatus in this embodiment employs a monochrome image forming apparatus, it may employ a so-called tandem type color image forming apparatus including plural photoconductor drums or a so-called cycling type color image forming apparatus in which a transfer process is repeatedly performed on an intermediate transfer member by a single photoconductor drum and toner images overlapped on the intermediate transfer member are collectively transferred on a paper. Even in this case, the above-described fixing device may be employed as a fixing device of the tandem type color image forming apparatus or the cycling type color image forming apparatus.

### EXAMPLE

In an example, the adjustment of the reference time in the B region shown in FIG. 6 is repeatedly performed unlike the flow illustrated in the above embodiment (See FIG. 5).

In this example, the heating roll begins to be heated when the surface temperature of the heating roll is less than 60° C., and the temperature-rising time from 110° C. to 125° C. is measured.

Here, if the heating roll is heated at 100° C. close to 110° C. (a temperature-rising measurement starting point in this example), for instance, since it takes heat from a heat source emitting heat from the inside of the heating roll some time to be transmitted to the surface of the heating roll, apparent temperature-rising becomes smooth. In addition, since there is a response delay in transmission of heat from a thermosensitive surface of the temperature sensor to a thermosensitive element of the temperature sensor, measurement precision becomes lowered. Accordingly, when the heating roll begins to be heated at temperature (less than 60° C. in this example) sufficiently lower than the temperature-rising time measurement starting point), it is preferable to measure the temperature-rising time in the B region (110 to 125° C.).

In the example, an average value of accumulated values (accumulation AVE) of a measurement result (temperature-rising time) and a standard deviation (a) of the accumulated values are calculated according to the number of times of measurement, and a multiplication of (accumulation AVE+3σ) by an adjustment coefficient (adjustment width) subtracted according to the number of times of measurement is calculated as a reference time adjustment result.

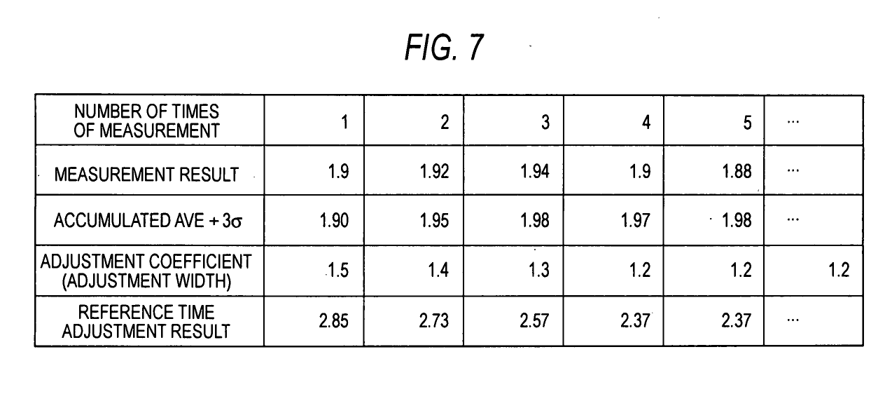

As shown in FIG. 7, repeating the number of times of measurement, the measurement result is obtained as follows: 1.9, 1.92, 1.94, 1.9 and 1.88 (sec). From this measurement result, (accumulation AVE+3σ) is obtained as follows: 1.90, 1.95, 1.98, 1.97 and 1.98, as shown in the figure. Next, by multiplying (accumulation AVE+3σ) by the adjustment coefficient gradually diminishing from 1.5 to 1.2 as shown in the figure, the reference time adjustment result for each number of timed of measurement is calculated.

The reference time adjustment result shows gradually diminishing numerical values. Here, the adjustment coefficient is a properly selected numerical value and has a lower limit value larger than 1.0. If the lower limit value is excessively larger than 1.0, there may occur malfunction due to an excessive margin. Accordingly, it is preferable to select the adjustment coefficient in the course of verification by an image forming apparatus of the same type.

In this way, in the example, the reference time from the reference time adjustment result is compared with an actual measurement result (which will become a next measurement result). As a result of the comparison, if the actual measurement result exceeds the reference time, it is determined that there occurs abnormality of winding of papers, thus allowing detection of the abnormality.

Typically, a temperature-rising speed of the surface of the heating roll of the fixing device is different for each apparatus due to deviation of thickness of core (rigid core) of the heating roll, deviation of thickness of the release layer, deviation of rated power of the halogen heater, deviation of responsiveness of the temperature sensor, etc. Accordingly, it must be designed to obtain a temperature-rising speed at which malfunction does not occur in consideration of deviations of these parts. In addition, while a voltage of the commercial power has a large deviation depending on installation environments, it has little deviation in the same installation environment. Accordingly, in order to reflect these conditions sufficiently, the reference time may be strictly adjusted as shown in this embodiment. In addition, in order to prevent malfunction in detection of abnormality of winding of papers around the heating roll and realize the abnormality detection with high precision, it is recognized that it is effective to learn deviations of the fixing device, differences in installation environments, repetition errors, etc.

What is claimed is:

1. A fixing device for fixing a toner image on a recording material, comprising:
a fixing member having a heat source;
a sensor which senses a surface temperature of the fixing member;
a measuring section which obtains temperature-rising time information of the fixing member based on information from the sensor;
an abnormality determining section which compares the temperature-rising time information obtained by the measuring section with reference value information to determine whether or not an abnormality exists; and
an adjusting section which adjusts the reference value information of the abnormality determining section.

2. The fixing device according to claim 1,
wherein the measuring section obtains the temperature-rising time information of the fixing member based on information from the sensor under a condition of operating the fixing member in a temperature-rising mode.

3. The fixing device according to claim 1, further comprising:
a heat controlling section which supplies power to the heat source, and reduces the power supply when the abnormality determining section determines an abnormality exists.

4. The fixing device according to claim 1,
wherein the adjusting section does not operate under a condition where a temperature of the fixing member prior to heating is equal to or higher than a predetermined temperature.

5. The fixing device according to claim 1,
wherein the adjusting section operates at an initial starting of the fixing device after installation of the fixing device or exchange of the fixing member.

6. The fixing device according to claim 5,
wherein the adjusting section operates when a password is input.

7. The fixing device according to claim 1,
wherein the fixing member has identification information different from information of other fixing members, and
the adjusting section operates when new identification information is recognized.

8. The fixing device according to claim 1,
wherein the adjusting section repeatedly operates and repeatedly sets the reference value until the abnormality determining section determines a first abnormality exists.

9. The fixing device according to claim 8,
wherein the adjusting section sets a new reference value based on the obtained temperature-rising time information to gradually reduce an adjustment width, ever time the reference value is repeatedly set.

10. The fixing device according to claim 1,
wherein the fixing member includes an irreversible reaction member which generates an irreversible reaction when the surface temperature of the fixing member reaches a predetermined temperature before the surface temperature reaches a fixable temperature, and
the adjusting section sets the reference value when the irreversible reaction member does not cause the irreversible reaction.

11. The fixing device according to claim 1,
wherein the adjusting section sets a reference value based on temperature-rising time information between at least two different temperatures before the surface temperature of the fixing member reaches a fixable temperature.

12. The fixing device according to claim 11,
wherein the abnormality determining section compares the temperature-rising time information between the at least two different temperatures during warming up and time information on consecutive application of current to the heat source under a standby state with reference value information based on the reference value, and determines that an abnormality exists when it is determined that at least one of the temperature-rising time information and the time information on consecutive application of current to the heat source is abnormal.

13. The fixing device according to claim 1, comprising:
a plurality of the sensors,
wherein the adjusting section sets each reference value for each of the plurality of the sensors, and
the abnormality determining section compares a plurality of temperature-rising time information obtained based on information from the plurality of the sensors with respective reference information, and determines that an abnormality exists when it is determined that there exists abnormality in at least one or the plurality of the temperature-rising time information.

14. An image forming apparatus, comprising:
an image forming section which forms a toner image on a recording material; and
a fixing device which fixes the toner image on the recording material,
wherein the fixing device includes:
a fixing member having a heat source;
a sensor which senses a surface temperature of the fixing member;
a measuring section which obtains temperature-rising time information of the fixing member based on information from the sensor;
an abnormality determining section which compares the temperature-rising time information obtained by the measuring section with reference value information to determine whether or not an abnormality exists; and
an adjusting section which adjusts the reference value information of the abnormality determining section.
